(19) United States
(12) Patent Application Publication
(10) Pub. No.: US 2007/0245649 A1
(43) Pub. Date: Oct. 25, 2007

(54) Exterior casing trim

(76) Inventors: Jerome C. Habeck, Westfield, IN (US); Stanley Gursky, Yardley, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/408,780

(22) Filed: Apr. 21, 2006

(51) Int. Cl. E06B 1/04

(52) U.S. Cl. 52/212

(57) ABSTRACT

Window trim designs are disclosed for use in commercial and residential building construction and repair. Brick mold, flat trim, and sill nose designs are disclosed, each having a similar structural arrangement configured to correspond with receiving structures of a window frame, and to lock and seal the trim to the window frame. Each design has a co-extruded flexible seal that engages the associated window frame member to shed water due to rain, etc. A secondary caulk/gasket seal is also provided between the trim and window frame. The external surfaces of the trim designs are embossed to mimic the appearance of wood. The trim designs may be cut, mitered and joined to provide a “picture frame” trim appearance. Alternatively, the provision of a sill profile allows the assembly of a more traditional window trimming appearance, with brick mold or flat trim on three sides, and sill member on the bottom.

### FIELD OF THE INVENTION

The present invention relates to trim for exterior window casings in commercial and residential building construction, and more particularly to a trim system that replicates the look of wood trim while functioning to easily attach to and protect an exterior window frame.

### BACKGROUND OF THE INVENTION

Modern window frames and frame members are typically prefabricated members constructed from vinyl, aluminum, or composite materials. The window frames are installed during new construction of a building, such as a house, or during replacement of existing windows. During new construction, a window frame is installed within a rough opening formed within and defined by the frame of a building structure. The window frame may include a nailing flange extending radially from the window frame and around the rough opening, and during installation, nails, staples or other fastening means may be used to secure the nailing flange, and thus the window frame, to the plywood sheathing of the building.

Prefabricated window frame members are often formed from a material such as vinyl or polyvinyl chloride (PVC) using extrusion processes. Molten metal or plastic is forced, drawn or extruded through a die for shaping into window frame members. After extrusion, the extruded window frame member continues to a cooling tank section or calibrator where it is reshaped and cooled in order to harden the member. The member may then be cut into usable or transportable lengths for use as a window frame member.

Trim members, some referred to as “brick mold” may be applied to the exterior periphery of the window frame to provide a finished appearance. Original trim members were made of wooden moldings which were mitered to provide a cover for the rough window frame. These trim members also extended beyond the outer periphery of the window frame to cover a portion of the siding or brick facing of the house structure to which the window frame is attached. The use of wooden trim members required careful sealing of the miter joints and the connections between the trim, the window frame, and the siding/brick facing to prevent moisture accumulation that could lead to premature rotting or other degradation of the trim, window and/or building structure. More modern approaches involve the use of vinyl trim members that are impervious to such moisture-induced rotting. Such vinyl trim members, however, did not completely mimic the look of real wood. Faced with a choice, customers resisted use of such vinyl trim members based on the lack of an aesthetically pleasing design.

Additionally, when vinyl trim members are used, it is still important that the trim members form a desired seal with the window frame to prevent moisture from penetrating between the trim and the window frame. Previous vinyl trim members used a variety of techniques to address this moisture ingress problem, including the use of caulking between the trim and frame, as well as the implementation of drain or “weep” holes in the structure to allow collected water to drain away from the frame, trim and building structure. These approaches, however, can be costly to implement from a manufacturing and/or manpower perspective. Additionally, they may require periodic maintenance, for example, to remove and replace worn or damaged caulk.

Thus, there is presently a need for a highly durable and easy to manufacture trim system for use with new construction and replacement windows. Further, there is a need for an aesthetically pleasing and cost effective trim system that can be attached to a window frame to effectively conceal portions of a siding or sheathing product attached to a building. There is also a need for a trim system that can easily and inexpensively seal the associated window frame to provide long term protection against moisture ingress.

### SUMMARY OF THE INVENTION

A window trim molding segment is disclosed. The molding segment may comprise a first portion for engaging a window frame member at a first location. The first portion may have a first flexible sealing element for engaging said window frame member to provide a substantially water-tight seal between the molding segment and the window frame member. The molding segment may have a second portion for engaging said window frame at a second location. The second portion may be configured to receive a fastener for fixing the molding segment to the window frame. The molding segment may further have a third portion for engaging a building structure. The third portion may optionally comprise an elongated flange element having sufficient lateral extension to allow a fastener to be received by said flange element to fix the molding segment to an adjacent building structure. The first, second and third portions may comprise a material having a first hardness, flexibility or stiffness and the flexible sealing element may comprise a material having a second hardness, flexibility or stiffness wherein the first hardness or stiffness is greater than the second hardness or stiffness, and the first flexibility is less than the second flexibility.

A molding segment is disclosed for use in window trimming. The molding segment may comprise a first portion for engaging a window frame member at a first location, the first portion having an integral flexible sealing member for engaging the window frame member to provide a water-tight seal between the molding segment and the window frame member. The molding segment may have a second portion for engaging said window frame at a second location, the second portion configured to receive a fastener for fixing the molding segment to the window frame. The molding segment may further have a third portion for engaging a building structure, the third portion comprising an elongated flange element for receiving a fastener to fix the molding segment to an adjacent building structure. The first, second and third portions comprise a material which is relatively inflexible and the integral flexible sealing member comprises a material which is relatively flexible, wherein the integral flexible sealing member is biased against an exterior surface of the window frame member.

A molding segment comprising: a first portion for engaging a window frame member at a first location, the first portion having an integral flexible sealing member for engaging the window frame member to provide a water-tight seal between the molding segment and the window frame member; a second portion for engaging said window frame at a second location, the second portion configured to receive a fastener for fixing the molding segment to the window frame a third portion for engaging a building structure, said third portion comprising an elongated flange element for receiving a fastener to fix the molding segment to an adjacent building structure; wherein the first, second and third portions comprise rigid PVC having a first hardness and the integral flexible sealing member comprises flexible PVC having a second hardness, wherein the first hardness is greater than the second hardness.

### BRIEF DESCRIPTION OF THE DRAWINGS

The accompanying drawings illustrate preferred embodiments of the invention so far devised for the practical application of the principles thereof, and in which:

FIG. 1 is a front elevation view of a typical window frame assembly;

FIG. 2A is a cross section view of the window frame assembly of FIG. 1 taken along line 2-2, showing an exemplary window trim piece connected to an exemplary window frame structure; FIG. 2B is a detail view of the connection between the window trim piece and the window frame structure of FIG. 2A; FIG. 2C is an alternative detail view of the connection between the window trim piece and the window frame structure of FIG. 2A;

FIG. 3 is a cross section view of the window frame assembly of FIG. 1, taken along line 2-2, showing an alternative design for a window trim piece connected to the exemplary window frame structure;

FIG. 4 is a cross section view of the window frame assembly of FIG. 1, taken along line 4-4, showing a window trim sill nose piece connected to an exemplary window frame structure;

FIGS. 5A and 5B are first and second cross section views of the window frame assembly of FIG. 1, taken along line 5-5;

FIGS. 6A through 6B are first, second, third and fourth cross section views of the window frame assembly of FIG. 1, taken along line 6-6.

### DETAILED DESCRIPTION

A design is disclosed for exterior casing trim for vinyl windows having a wood-like appearance. These exterior casing trim designs replicate the traditionally trimmed look of wood trim on windows and doors, and will be applied to finished widows or doors to provide this look. A four-sided frame of the trim will be assembled, and the window frame then will be installed inside it. The two may be fastened together using sealant, staples, or other fastening methods.

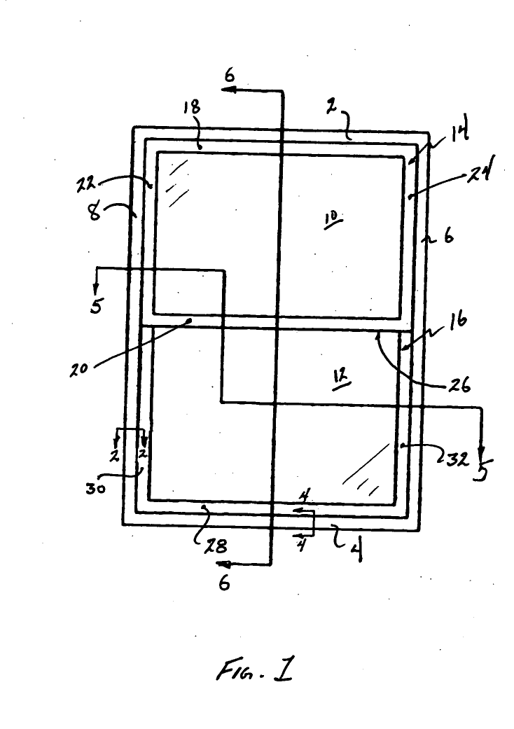

Referring to FIG. 1, a typical window frame assembly 1 is shown having a header frame member 2, a sill frame member 4, jamb frame members 6, 8 and first and second glass panels 10, 12, at least one of which panels may be slidably mounted with respect to the frame members. The window frame assembly 1 may be a single hung or double hung design (though fixed glazed windows are not excluded), commonly used in both residential and commercial applications. The term “single hung” refers to a window design in which the outer frame (constituted by header, sill and jamb members) contains a fixed glazed region and a slidable sash frame 14 or 16 movable relative thereto. The term “double hung” refers to a window design having two relatively movable sash frames 14, 16 and no fixed glazed region. Furthermore, the slidable sashes may move vertically or horizontally.

Additionally, in the illustrated embodiments disclosed herein, sashes 14 and 16 are shown as having double glazing, i.e., where each glass panel 10, 12, comprises a pair of glass sheets, respectively. However, it will be appreciated that different glazing configurations may also be utilized, and single or triple glazed windows are also within the scope of the present disclosure.

As illustrated in FIG. 1 the perimeters of glass panels 10, 12 are encased within their respective sashes 10, 14 and supported by top, bottom and side portions such as top rail 18, bottom rail 20, left stile 22, and right stile 24 of sash 14 and top rail 26, bottom rail 28, left stile 30 and right stile 32 of sash 16, which allow for slidable motion of the glass panels relative to header frame member 2, sill frame member 4 and jamb frame members 6, 8.

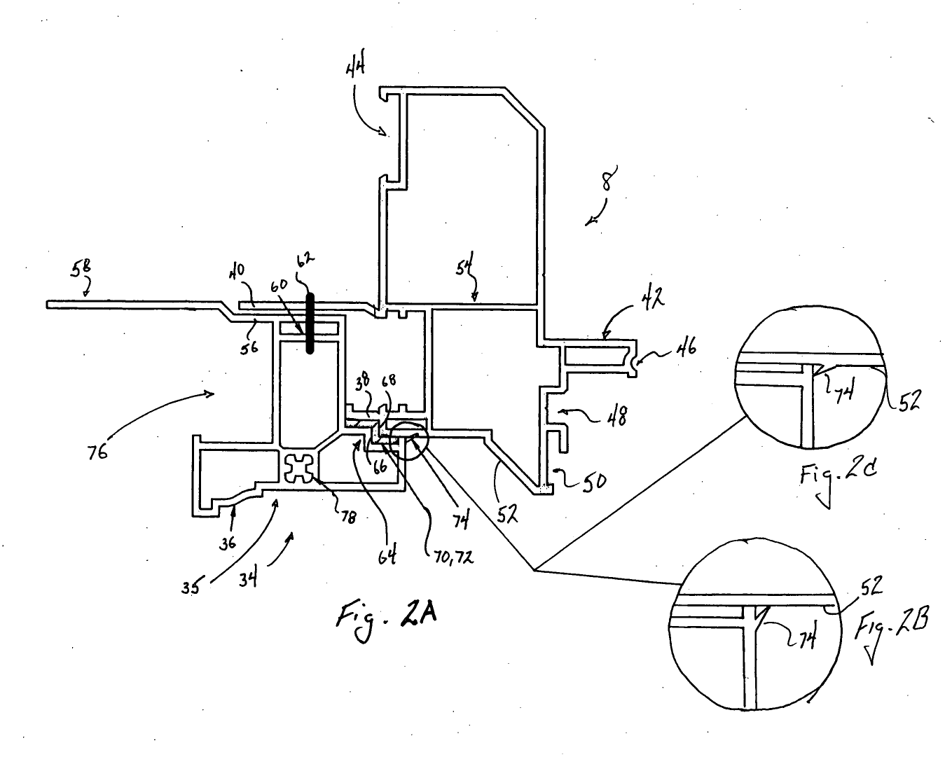

Referring to FIG. 2A, a brick mold casing 34 is shown in cross section engaged with a portion of jamb frame member 8. The brick mold casing 34 may comprise an exterior portion 35 having a surface 36 that is formed in the shape of a traditional wood molding. The surface 36 may have a smooth appearance, or it may be embossed to provide the appearance of wood grain. The brick mold casing 34 may be configured to engage corresponding structures of the associated window frame, and to allow the casing 34 to be fixed to the building structure. In the illustrated embodiment, the jamb frame member 8 comprises first and second substantially parallel flange members 38, 40. Second flange member 40, is often referred to as a nailing flange for new construction applications, as it will be butted against the building structure when installed in the window opening, and has a large surface suitable for receiving a fastener such as a nail, staple, or the like. In remodeling replacement window applications, the nailing flange is often eliminated.

The jamb frame member 8 may have a variety of additional features typical for such frame elements, such as a window seat 42, an interior accessory channel 44 for accepting and securing interior window accessories such as trim (not shown) to the window frame assembly 1, a grid slot 46 for permitting a decorative grid or muntin accessory to be secured over a window that is secured to the window seat 42, a weep channel 48 for draining water away from the window, and glazing bead channel 50 shaped to permit decorative glazing beads (not shown) to be secured to a window frame member. The jamb frame member 8 may further have an exterior surface 52 designed to be exposed to the weather when the window frame assembly 1 is installed. One or more support columns 54 may also be provided within the jamb frame member 8 to add stability to the frame member and to enable the member to maintain its manufactured form throughout the life of the frame. It will be appreciated that although these enumerated frame element features are described in relation to the jamb frame member 8, they may also be incorporated into header frame member 2, sill frame member 4 and jamb frame member 6.

The brick mold casing 34 may have an inner facing portion 56 for engaging the second flange member 40. The inner facing portion 56 may comprise an extending nail fin portion 58 which is positioned to abut the building structure when the window frame assembly 1 is installed. This nail fin portion 58 provides a broad surface for receiving nails, staples or the like to fix the window frame assembly to the building structure in new construction (though it is not always needed in the replacement market). For nailing purposes, one or more openings or grooves (not shown) may be provided in the nailfin portion 58 to make nailing or stapling easier. The inner facing portion 56 of the brick mold casing 34 may comprise a reinforcing, or double, wall 60 for receiving a staple 62 or other appropriate fastener to attach the brick molding casing 34 to the window frame (in this case the jamb frame member 8).

An inner perimeter region 64 may be shaped to conform to a portion of the first flange member 38 of the jamb frame member 8. In the illustrated embodiment, the inner perimeter region may comprise a “z-shaped” surface 66 configured to match a corresponding surface 68 of the first flange member 38 so that a “z-shaped” groove 70 is formed therebetween. Caulk 72 or similar gasket material may be introduced within this groove (by application to one or both of surfaces 66, 68) during fit-up of the brick mold casing 34 to the jamb frame member 8. This caulk 72 or gasket material may prevent the ingress of moisture between the brick mold casing 34 and the jamb frame member 8.

To further minimize the penetration of moisture between the two pieces, a flexible seal 74 may be provided on the brick mold casing 34 directly adjacent to the exterior surface 52 of the jamb frame member 8. As shown in greater detail in FIG. 2B, this flexible seal 74 is designed to engage the exterior surface 52 of the frame member 8, and to deform slightly to form a tight seal between the brick molding casing 34 and the frame member 8. This deformable seal feature will enable the assembly to “shed” water from the exterior, minimizing or eliminating the accumulation of moisture at the external junction of the casing and frame member. With previous designs, water could “pool” at the casing/frame interface, which may cause penetration of water between the window casing and the casing profile. Thus, the flexible seal 74 and caulk 72 may act as first and second lines of defense against water infiltration. This provides maximum assurance that water will not penetrate to the wall of the structure.

In one embodiment, the flexible seal 74 is co-extruded with the remainder of the casing 34. As such, the casing 34 may be fabricated from a substantially rigid PVC material having a hardness of from about 60 to about 85 Shore D, while the flexible seal 74 may comprise a relatively flexible PVC material having a hardness of from about 45 to about 100 Shore A. In a preferred embodiment, the rigid PVC material may have a hardness of about 65 Shore D, while the flexible PVC material may have a hardness of about 70 Shore A. Alternatively, the flexible seal 74 may be manufactured as a separate piece and applied to the casing 34 by gluing, heat sealing or other appropriate technique. Additionally, it may be possible to manufacture the casing 34 and flexible seal 74 from the same material, where the flexible seal 74 is formed in a reduced thickness sufficient to provide a desired degree of flexibility for sealing purposes.

It is noted that although the embodiment of FIGS. 2A and 2B shows the flexible seal 74 as being formed on the brick mold casing 34 to seal against exterior surface 52 of the window frame (jamb frame member 8), the flexible seal 74 could instead be formed as an integral part of the window frame member and configured to seal against the casing 34. This alternative arrangement is shown in FIG. 2C.

Referring again to FIG. 2A, the brick mold casing 34 may comprise an exterior cladding pocket 76 into which the cladding (e.g., brick, siding) of the building structure is received during construction. The cladding pocket 76 is often referred to as a “J-channel.” In the present design, the cladding pocket 76 is defined as the space between the exterior portion 35 and the nailing flange 58. The cladding pocket 76 is made wider than with prior J-channel designs to enable the casing to accept higher butt heights associated with wood or fiber cement siding. The cladding pocket 76 is sized to accept a siding or sheathing product attached to the building structure and to partially cover the ends of the siding or sheathing. The cladding pocket 76 thus may have sufficient depth to adequately cover the ends of the siding or sheathing during expansion and contraction resulting from temperature changes. The cladding pocket 76 also helps to exclude water from the siding or sheathing and to cover misalignments of the ends of the sheathing or siding.

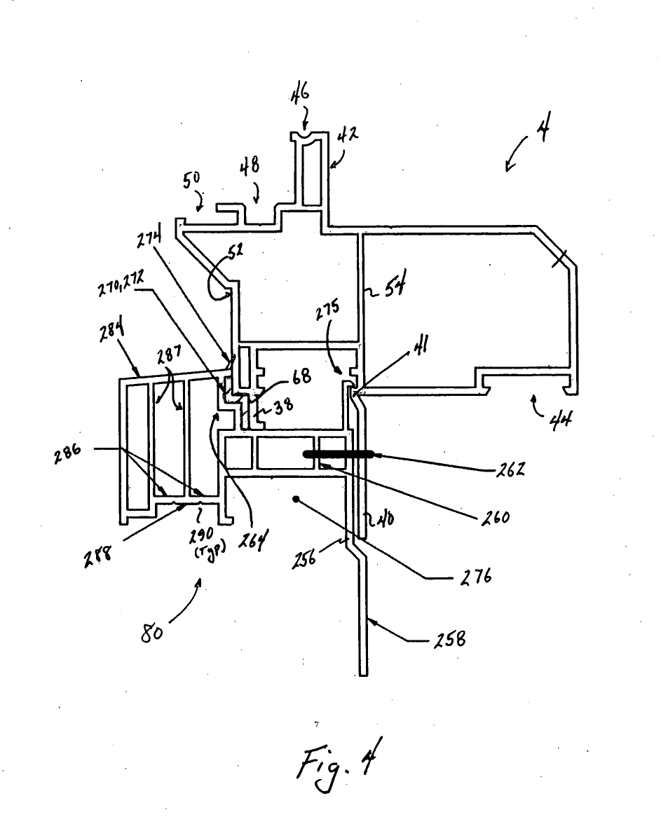

Also shown in FIG. 2A is a screw port 78 for enabling the attachment of the brick mold casing 34 to an optional sill nose profile 80 (see FIG. 4). In such an arrangement, three sides of the trim assembly may comprise brick mold casing 34 (i.e., the brick mold casing 34 may be applied to the header frame member 2 and the jamb frame members 6, 8), while the bottom of the trim assembly comprises sill nose profile 80, applied to the sill frame member 4. This combination of brick mold casing 34 and sill nose profile 80 may create an appearance that mimics a traditionally trimmed window. By contrast a “picture window” arrangement is one in which the window frame is surrounded on all four sides by the identical brick mold casing 34 pieces. Where a sill nose profile 80 is used, the screw port 78 enables the brick mold 34 casing to be positively engaged to the sill nose profile by inserting a screw or other appropriate fastener, as will be described in greater detail below.

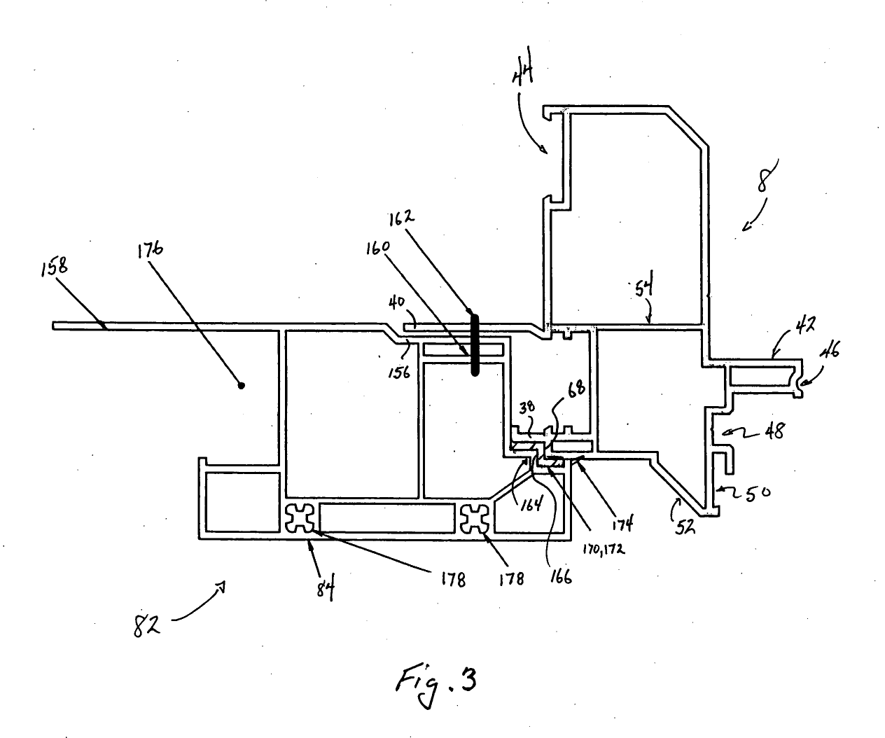

Referring to FIG. 3, an alternative to the brick mold casing 34 is shown. Flat trim casing 82 may be used to provide window trim arrangement with less filigree than that provided by the brick mold casing 34 (it is expected that end user will select one or the other largely based on aesthetics.) The exterior surface 84 of the flat trim casing 82 may be substantially flat, and may have embossing or other surface finishing to provide a desired wood grain appearance. The flat trim casing 82 may engage identical or substantially similar window frame members 2, 4, 6, 8 as described above in relation to brick mold casing 34. Again, although the illustrated embodiment shows the flat trim casing 82 engaged with jamb frame member 8, it will be appreciated that similar or identical features will be provided in the sill and header frame members so that the casing 82 will engage each in the same fashion. Thus, the jamb frame member 8 shown in FIG. 3 may have all of the features as the jamb described in relation to FIGS. 2A, B, including window seat 42, interior accessory channel 44, grid slot 46, weep channel 48, glazing bead channel 50, internal support column 54 and external surface 52.

Since the flat trim casing 82 will engage the same window frame members as the brick mold casing 34, the flat trim casing will have substantially the same structural configuration as the brick mold casing 34 with regard to the manner in which it engages the associated window frame member (header 2, sill 4 and jamb 6, 8 frame members). Thus, the flat trim casing 82 may have an inner facing portion 156 for engaging the second flange member 40 of the jamb frame member 8. The inner facing portion 156 may comprise an optional extending nail fin portion 158. The inner facing portion 156 of the flat trim casing 82 may further comprise a reinforcing wall 160 for receiving a staple 162 or other appropriate fastener for attaching the flat trim casing 82 to the window frame. An inner perimeter region 164 may be shaped to conform to a portion of the first flange member 38 of the jamb frame member 8. As with the brick mold casing 34, the inner perimeter region 164 of the flat trim casing 82 may comprise a “z-shaped” surface 166 that forms a “z-shaped” groove 170 with opposing surface 68 of the jamb member 8. Caulk 172 or gasket material may be provided within the groove 170 to prevent the ingress of moisture between the flat trim casing 82 and the jamb frame member 8.

Flexible seal 174 may be provided on the flat trim casing 82 directly adjacent to the exterior surface 52 of the jamb frame member 8. The flexible seal 174 may have all of the characteristics of the seal 74 described previously in relation to FIGS. 2A, B. Thus, seal 174 may comprise a flexible PVC material that is co-extruded with the rigid PVC material used to form the remainder of the casing 82.

Additionally, the flat trim casing 82 may comprise an exterior cladding pocket 176 into which the cladding (e.g., brick, siding) of the building structure is received during construction. One or more screw ports 178 may be provided adjacent the external surface 84 of the casing 82 to enable attachment of an optional sill nose profile 80 (see FIG. 4) as previously described in relation to the arrangement of FIGS. 2A, B.

Referring to FIG. 4, sill nose profile 80 is shown. As previously noted, this sill nose profile 80 may be attached to the sill frame member 4 to provide the appearance of a traditionally trimmed window, and may be used in combination with either the brick mold casing 34 or the flat trim casing 82. The sill nose profile 80, like the flat trim casing 82, may have substantially the same structure for engaging the sill frame member 4 as the brick mold casing 34. Thus, the sill nose profile 80 may have inner facing portion 256 with extending nail fin portion 258 for engaging the second flange member 40 of the sill frame member 4 and for allowing the profile 80 to be fixed (e.g., nailed or stapled) to the adjacent building structure. Reinforcing wall 260 may be provided for receiving a staple 262 or other appropriate fastener for attaching the sill nose profile 80 to the sill frame member 4. Inner perimeter region 264 may be shaped to conform to a portion of the first flange member 38 of the sill frame member 4, and to form a “z-shaped” groove 270 via the opposition of surfaces 266 and 68. Sealing caulk 272 or gasket material may be provided within the groove 270.

To provide an additional degree of vertical stability to the engagement between the sill nose profile 80 and the sill frame member 4, a locking tab 275 may be provided adjacent the inner facing portion 256 of the sill nose profile 80 to engage a corresponding lip 41 on the sill frame member 4. This lip 41 may be located adjacent the intersection of the first flange member 4 and the support column 54 of the sill frame member 4 to provide a stiff surface for supporting the sill nose profile 80. Thus, the interaction between the corresponding horizontal surfaces of the tab 275 and lip 41 enable direct transmission of vertical force (once the window frame assembly has been installed in the building structure) between the profile 80 and frame member 4 so that the profile will not “sag” over the lifetime of the unit. This additional support is highly advantageous because the staples 262, while providing good lateral support to fix the sill nose 80 to the sill frame 4, may not provide the desired degree of long term vertical support between the pieces.

As previously noted, the sill nose profile 80 may be fixed to the adjacent pieces of brick mold casing 34 or flat trim casing 82 to form a desired window trim assembly for covering the perimeter formed by the window frame members 2, 4, 6, 8. Thus, one or more screw cavities 286 may be provided within the profile 80 through which one or more screws (not shown) may be inserted to engage the screw ports 78, 178 (FIGS. 2A, 3) of the adjacent brick mold or flat trim casing piece 34, 82. These screw cavities 286 may be formed as the spaces between adjacent vertical support members 287 formed within the profile 80 to provide vertical stability to the sill nose. A recessed portion 288 may be provided adjacent to the screw cavities 286 to conceal the heads of the screws from view upon installation. Additionally, a groove or recess 290 may be provided through the wall of the profile 80 directly underlying the screw cavities 286 to enable easy insertion of the screws through the profile wall.

The external surface 284 of the sill nose profile 80 may be sloped away from the window in a traditional manner so as to allow water to run away from the window frame. The external surface 284 may be embossed or have other surface finishing to provide a desired wood grain appearance, similar to the other trim elements previously described.

A flexible seal 274, similar to those previously described in relation to FIGS. 2A, B and 3 may be provided on the sill nose profile 80 for sealing with the exterior surface 52 of the sill frame member 4. Thus, flexible seal 274 may have all of the characteristics of the seals 74, 174 as previously described. The seal 274 may be particularly valuable for use with the sill nose profile 80 because it will reside in the portion of the window that is particularly vulnerable to water pooling due to exposure to the weather.

The sill nose profile 80 may further comprise an exterior cladding pocket 276, similar for receiving building structure cladding. This exterior cladding pocket 276 may be substantially the same as the cladding pockets 76, 176 described in relation to FIGS. 2A and 3.

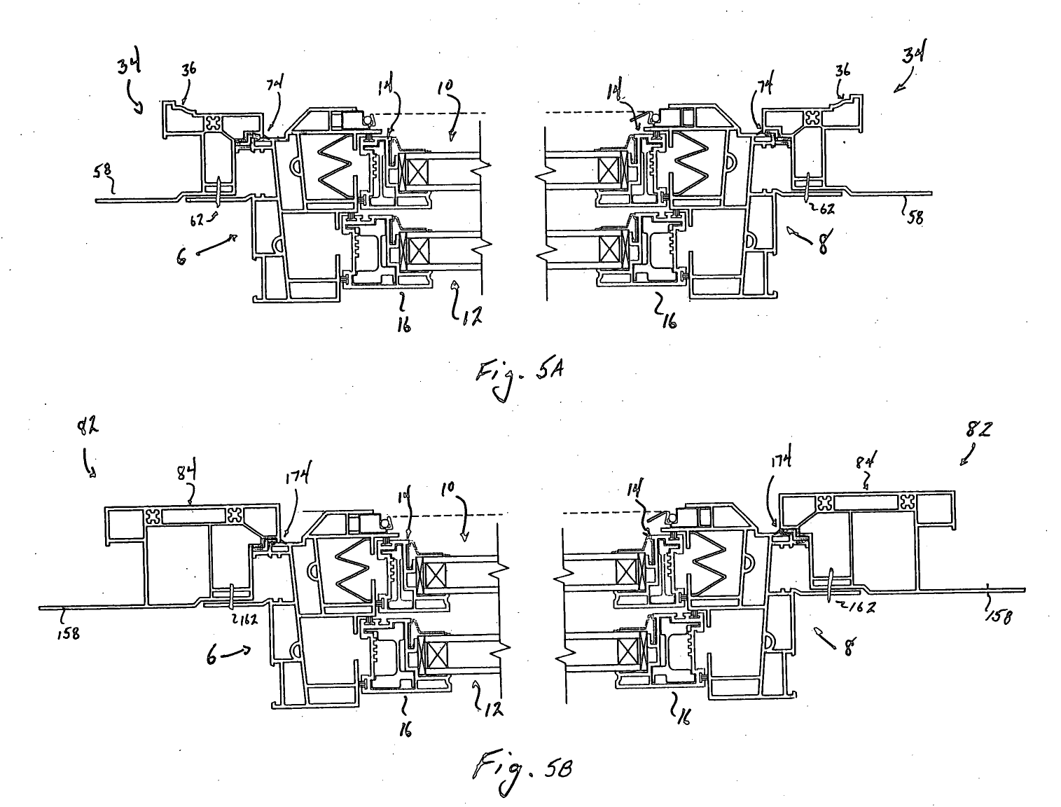

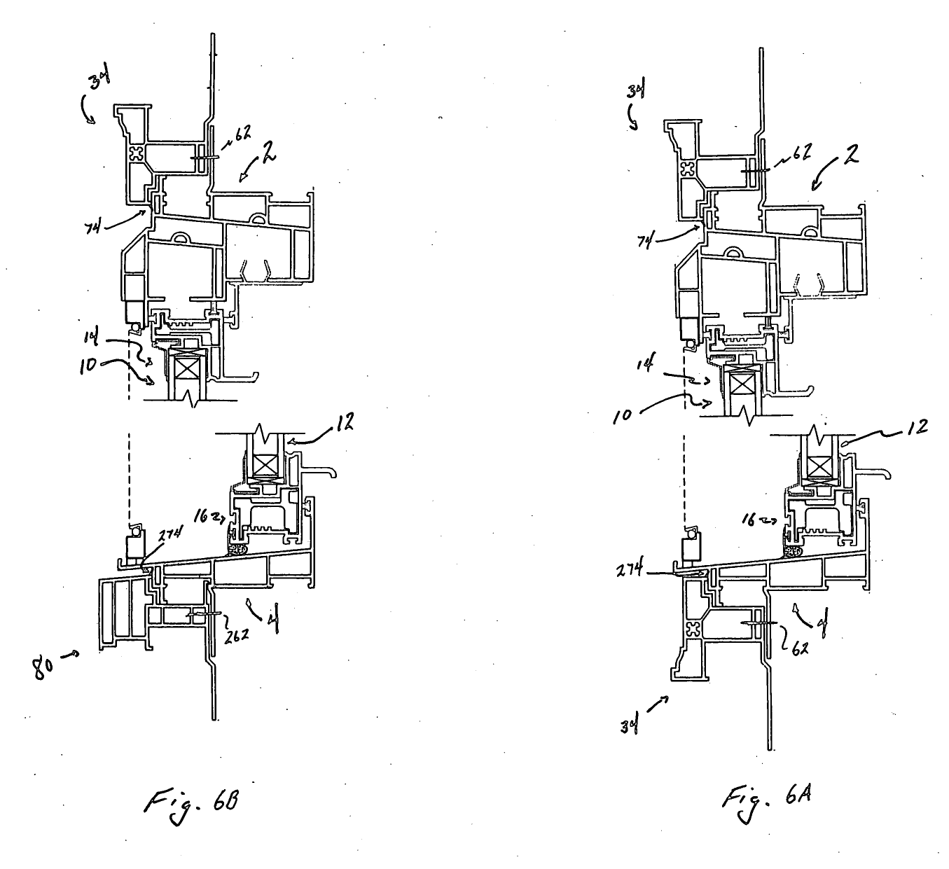

Referring now to FIGS. 5A and 5B, the brick mold casing 34 and flat trim casing 82 are shown in the context of a typical window frame assembly 1, as viewed from above (taken along line 5-5 of FIG. 1). Thus, in FIG. 5A, brick mold casings 34 are shown engaged with respective jamb frame members 6, 8. First and second glass panes 10, 12 are supported by sash frames 14, 16, which engage the jamb frame members 6, 8 on either side. In FIG. 5B, flat trim casing 82 engages respective jamb frame member 6, 8 in substantially the same manner as shown for brick mold casings 34 in FIG. 5A. Visible in both figures is the integral flexible seal 74, 174 which allows the trim casings to shed water away from the respective window frame elements.

A review of FIGS. 5A and 5B reveals that, the structure of jamb frame members 6, 8 varies slightly from that shown in FIGS. 2A-4. The basic inter-engaging structures, however, are substantially similar to those of FIGS. 2A-4. This illustrates the versatility of the presently disclosed design, as it is capable of being implemented with a variety of different window frame designs.

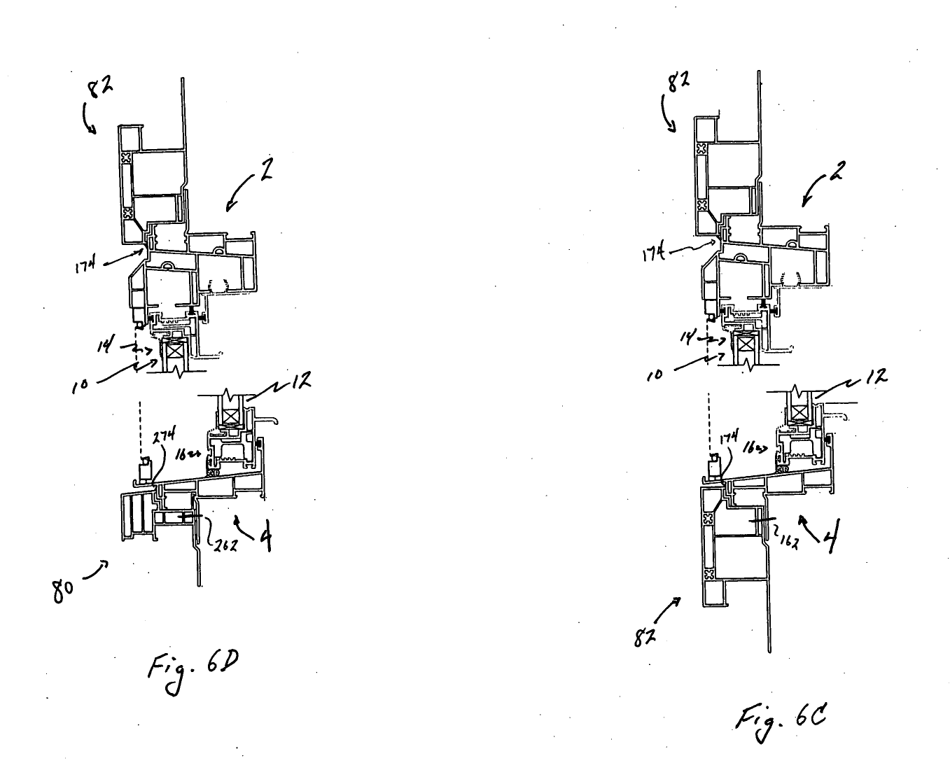

Referring to FIGS. 6A-6D, the brick mold casing 34, flat trim casing 82, and sill nose profile 80, shown in the context of a typical window frame assembly 1, as viewed from the side (along line 6-6 of FIG. 1). Thus, FIG. 6A shows a pair of brick mold casings 34 engaged with respective header frame member 2 and sill frame member 4, to provide a “picture frame” trim arrangement. FIG. 6B, by contrast, shows an upper brick mold casing 34 engaged with header frame member 2, and sill nose profile 80 engaged with sill frame member 4, thus providing the appearance of a traditionally trimmed window. Again, first and second glass panes 10, 12 are shown supported by sash frames 14, 16, which engage the header frame and sill frame members 2, 4, respectively. Visible in both figures is the integral flexible seal 74, 274 which allows the trim casings to shed water away from the respective window frame elements.

FIGS. 6C and 6D show a substantially identical “picture frame” and traditional window frame arrangements as those described in relation to FIGS. 6A and 6B, but with the substitution of flat trim casing 82 for the brick mold casing 34 of the previous figures.

The previous descriptions relate to the discrete interactions between individual trim and window frame structures. To manufacture and install a four-sided assembly of trim members to the respective four elements of a window frame (header 2, sill 4 and jambs 6, 8), four individual pieces of trim must be joined to provide a smooth, aesthetically pleasing frame structure. Thus, where a “picture frame” type trim assembly is desired, four individual pieces of brick mold casing 34 or flat trim casing 82 may be selected, cut, and mitered at each end in a manner typical for joining molding members. The casing pieces are then joined together, and finally fixed as an assembly to an associated window frame. In the embodiment in which the casings 34, 82 are manufactured from PVC, the individual trim elements may be hot plate welded together.

Where a sill nose profile 80 is used (FIGS. 6B, 6D), the brick mold casing 34 or flat trim casing 82 may be selected, cut and mitered to provide a three-sided assembly. A sill nose profile piece is then used to form the fourth side. The casing 34, 82 may then be coped at the end that will engage the sill nose 80 to provide a smooth connection between the two. A screw or screws (not shown) will then be inserted via the one or more screw cavities 286 in the sill nose profile 80, so that they may engage the appropriate screw ports 78, 178 (FIGS. 2A, 3) of the adjacent brick mold or flat trim casing piece 34, 82.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

What we claim is:

1. A window trim molding segment comprising:
a first portion for engaging a window frame member at a first location, the first portion having a first flexible sealing element for engaging said window frame member to provide a substantially water-tight seal between the molding segment and the window frame member;
a second portion for engaging said window frame at a second location, the second portion configured to receive a fastener for fixing the molding segment to the window frame;
a third portion for engaging a building structure, said third portion comprising an elongated flange element having sufficient lateral extension to allow a fastener to be received by said flange element to fix the molding segment to an adjacent building structure;
wherein the first, second and third portions comprise a material having a first stiffness and the flexible sealing element comprises a material having a second stiffness, wherein the first stiffness is greater than the second stiffness.

2. The window trim molding segment of claim 1, wherein the first, second and third portions comprise rigid polyvinylchloride (PVC).

3. The window trim molding segment of claim 2, wherein the first flexible sealing element comprises flexible PVC having a hardness of from about 45 to about 100 Shore A.

4. The window trim molding segment of claim 1, further comprising a second sealing element for engaging the window frame member, the second sealing element comprising caulk or gasket material.

5. The window trim molding segment of claim 4, wherein the molding segment comprises a brick mold casing, a flat trim casing or a sill nose profile.

6. The window trim molding segment of claim 1, further comprising a locking tab disposed adjacent the second portion, the locking tab having a laterally protruding portion configured to engage a corresponding lip of the window frame member to positively lock the molding segment to the window frame.

7. The window trim molding segment of claim 1, wherein the first, second and third portions comprise rigid PVC having a hardness of from about 60 to about 85 Shore D, and the first flexible sealing element is co-extruded with said first, second and third portions.

8. The window trim molding segment of claim 1, wherein the first portion has a surface comprising a wood grain contour.

9. A molding segment for use in window trimming, the molding segment comprising:
a first portion for engaging a window frame member at a first location, the first portion having an integral flexible sealing member for engaging the window frame member to provide a water-tight seal between the molding segment and the window frame member;
a second portion for engaging said window frame at a second location, the second portion configured to receive a fastener for fixing the molding segment to the window frame;
a third portion for engaging a building structure, said third portion comprising an elongated flange element for receiving a fastener to fix the molding segment to an adjacent building structure;
wherein the first, second and third portions comprise a material which is relatively inflexible and the integral flexible sealing member comprises a material which is relatively flexible, wherein said integral flexible sealing member is biased against the window frame member when the first portion engages the window frame member.

10. The molding segment of claim 9, wherein the first, second and third portions comprise rigid polyvinylchloride (PVC) having a hardness of from about 60 to about 85 Shore D.

11. The molding segment of claim 10, wherein the first flexible sealing member comprises flexible PVC having a hardness of from about 45 to about 100 Shore A.

12. The molding segment of claim 11, wherein the first flexible sealing member is co-extruded with the first, second and third portions.

13. The molding segment of claim 9, further comprising a second sealing element for engaging the window frame member, the second sealing element comprising caulk or gasket material.

14. The molding segment of claim 9, wherein the molding segment comprises a brick mold casing, a flat trim casing or a sill nose profile.

15. The molding segment of claim 9, further comprising a locking tab disposed adjacent the second portion, the locking tab having a laterally protruding portion configured to engage a corresponding lip of the window frame member to positively lock the molding segment to the window frame.

16. The molding segment of claim 1, wherein the first portion has a surface comprising a wood grain contour.

17. A molding segment comprising:
a first portion for engaging a window frame member at a first location, the first portion having an integral flexible sealing member for engaging the window frame member to provide a water-tight seal between the molding segment and the window frame member;
a second portion for engaging said window frame at a second location, the second portion configured to receive a fastener for fixing the molding segment to the window frame;
a third portion for engaging a building structure, said third portion comprising an elongated flange element for receiving a fastener to fix the molding segment to an adjacent building structure;
wherein the first, second and third portions comprise rigid PVC having a first hardness and the integral flexible sealing member comprises flexible PVC having a second hardness, wherein the first hardness is greater than the second hardness.

18. The molding segment of claim 17, wherein the first, second and third portions have a hardness of from about 60 to about 85 Shore D and the first flexible sealing member has a hardness of from about 45 to about 100 Shore A.

19. The molding segment of claim 17, wherein the first flexible sealing member is co-extruded with the first, second and third portions.

20. The molding segment of claim 9, further comprising a locking tab disposed adjacent the second portion, the locking tab having a laterally protruding portion configured to engage a corresponding lip of the window frame member to positively lock the molding segment to the window frame.
